(19) United States
(12) Patent Application Publication
(10) Pub. No.: US 2020/0119571 A1
(43) Pub. Date: Apr. 16, 2020

(54) BATTERY SOURCED POWER CONVERSION

(71) Applicant: Ardent Edge, LLC, Charlotte, NC (US)

(72) Inventors: Clayborne Dudley Taylor, JR., Charlotte, NC (US); Jason Robert Norman, Charlotte, NC (US); Michael Edward Brandt, Concord, NC (US)

(73) Assignee: Ardent Edge, LLC, Charlotte, NC (US)

(21) Appl. No.: 16/654,606

(22) Filed: Oct. 16, 2019

Related U.S. Application Data
(60) Provisional application No. 62/746,154, filed on Oct. 16, 2018.

(51) Int. Cl. H02J 7/00; H02M 3/155

(52) U.S. Cl. CPC H02J 7/0063; H02J 2007/0067; H02M 3/155

(57) ABSTRACT

Embodiments of the present invention are directed to a battery sourced power conversion system and a balanced architecture employed in the battery sourced power conversion system comprising a first plurality of battery units connected in series, a plurality of switches, each switch being connected to one of the plurality of battery units, and at least one controller connected to the first plurality of battery units, wherein the at least one controller is configured to control the plurality of switches to generate a square wave output from each battery unit of the first plurality of battery units, wherein the square wave output associated with each battery units of the first plurality of battery units in combination form a desired output waveform having a plurality of steps.

### CROSS REFERENCE TO RELATED APPLICATION

This application claims priority to U.S. Provisional Patent Application Ser. No. 62/746,154, filed Oct. 16, 2018, entitled “Battery Sourced Power Conversion,” the entirety of which is incorporated herein by reference.

### FIELD OF THE INVENTION

The present invention relates to battery sourced power conversion system. The battery sourced power conversion system may be able to deliver power exceeding 10 Kilowatts (KW) (e.g., 50 Kilowatts).

### SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

In one embodiment, the present invention is directed to a battery sourced power conversion system connected to a load and a source. The battery sourced power conversion system includes a plurality of battery units connected in series and plurality of switches. Each of the plurality of switches is connected to one of the plurality of battery units. The battery sourced power conversion system also includes at least one controller connected to the plurality of battery units. The at least one controller is configured to control the plurality of switches to generate a voltage (in the form of a square wave) output from one or more of the battery units of the plurality of battery units, wherein the step up voltage outputs of the battery units of the plurality of battery units in combination form an output. In some embodiments, the output is a modified sinusoidal wave formed of a plurality of steps. In some embodiments, the output has a resolution of at least 50. In some embodiments, the output has a resolution of greater than 100. In some embodiments, the output has a resolution of greater than 500.

In some embodiments, the plurality of battery units comprises a first plurality of battery units, a second first plurality of battery units, and a third plurality of battery units and the plurality of switches comprises a first plurality of switches, a second plurality of switches, and a third plurality of switches. In such an embodiment, the at least one controller is configured to control the first plurality of switches, the second plurality of switches, and the plurality of switches to cause the first plurality of battery units, the second plurality of battery units, and the third plurality of battery units respectively to generate a first modified sinusoidal wave, a second modified sinusoidal wave, and a third modified sinusoidal wave respectively, where the first modified sinusoidal wave, the second modified sinusoidal wave, and the third modified sinusoidal wave in combination form a three-phase modified sinusoidal output that is the output of the battery sourced power conversion system.

In some embodiments, the at least one controller is configured to generate, using the plurality of battery units, the system output, the system output being substantially equal to a difference between an output of the source and a desired input of the load.

In some embodiments, the system output when combined with the source current forms the desired input current.

In some embodiments, the at least one controller is configured to control the plurality of switches to cause the plurality of battery units to provide the desired input current based on absorbing current.

In some embodiments, the at least one controller is configured to control the plurality of switches to cause the plurality of battery units to provide the desired input current based on discharging current.

In some embodiments, the at least one controller is configured to control the plurality of switches to cause the plurality of battery units to compensate for lower generation of the output of the source by discharging charged battery units of the plurality of battery units.

In some embodiments, the at least one controller is configured to control the plurality of switches to cause the plurality of battery units to compensate for higher generation of the output of the source by charging discharged battery units of the plurality of battery units.

In some embodiments, the at least one controller is configured to control the plurality of switches to maintain substantially the same overall duty cycle for each of the plurality of battery units.

In some embodiments, at least some battery units of the plurality of battery units are configured to supply positive voltage associated with the system output and at least some other battery units of the plurality of battery units are configured to supply negative voltage associated with the system output, the at least some other battery units having reverse polarity compared to the at least some battery units.

In some embodiments, the at least one controller is configured to control the plurality of switches to achieve a gradual rise and gradual fall of voltage associated with the system output.

In some embodiments, the system comprises a bypass mechanism for the plurality of battery units.

In some embodiments, the at least one controller is configured to control the plurality of battery units based on a transfer function.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

The features and functions of the invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 illustrates a battery sourced power conversion system, according to an embodiment of the present invention;

FIG. 2 illustrates a battery sourced power conversion system that is configured to deliver three-phase power, according to an embodiment of the present invention;

FIG. 3 illustrates a balanced architecture that may be utilized in the battery sourced power conversion system, in accordance with an embodiment of the present invention.

FIG. 4 illustrates a balanced architecture that may be utilized in the battery sourced power conversion system, in accordance with another embodiment of the present invention;

FIG. 5 illustrates the output waveform of the battery sourced power conversion system, in accordance with an embodiment of the present invention;

FIG. 6 illustrates an expanded view of the output waveform of the battery sourced power conversion system, in accordance with an embodiment of the present invention;

FIG. 7 illustrates the output waveform of the battery sourced power conversion system configured to deliver three-phase power, according to an embodiment of the present invention;

and

FIG. 8 illustrates a compensation waveform produced by the battery sourced power conversion system, in accordance with an embodiment of the present invention.

### DETAILED DESCRIPTION

The present invention now will be described more fully hereinafter with reference to the accompanying drawings, in which some, but not all embodiments of the invention are shown. This invention may be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The term “battery unit” as used herein may include any unit which stores energy. A battery unit may itself include multiple battery units. In one embodiment, a “battery unit” may include one or more individual cells. In one embodiment, a “battery unit” may include one or more modules. Each such modules may include a plurality of cells. In one embodiment, a “battery unit” may include one or more trays. Each such tray may include a plurality of modules, and each module may include one or more cells. In one embodiment, the term “battery unit” may include one or more racks. Each such rack may include a plurality of trays, each of the plurality of trays may include a plurality of modules, and each of the plurality of modules may include one or more cells. In one embodiment the term “battery unit” may include one or more containers, where each of the one or more containers includes a plurality of racks as, where each of the plurality of racks includes a plurality of modules, where each of the plurality of modules includes a plurality of cells.

Electricity is generated at power plants using various forms of energy and is transmitted and distributed through complex systems. Electric power is typically converted at various stages of such complex systems to facilitate such transmission and distribution.

In this regard, power plants may generate AC power or DC power depending on the type of energy and the type of generation method used in the power plants. However, transmission and distribution of AC power is more advantageous as it is typically easier to step-up or step-down the voltage of AC power as compared to DC power. Accordingly, if DC power is generated at a power station, such DC power is typically converted to AC power using power conversion systems. Additionally, generated power is typically stepped-up to higher voltages before transmission as transmitting higher voltage is more efficient for transmitting power over long distances because doing so helps to minimize losses. Following transmission, the voltage of electric power is then stepped down for distribution.

Energy storage systems may be used within electric power generation, transmission and distribution systems (e.g., at substations) for storing energy for later usage during periods of peak demand and/or low supply of power. Power conversion systems are typically utilized to make the generated energy or the energy stored within such energy storage systems usable within electric power transmission and distribution systems. For example, power rectifiers are employed to convert AC power generated by electric power generation systems to DC power for storing the excess energy in energy storage systems and power inverters are employed to convert DC power from such energy storage systems into AC power for transmission and distribution. As such, separate systems are typically used for converting energy for transmission of generated energy to the load or storage, storing the converted energy, and converting the stored energy.

Moreover, additional power factor correction equipment may be used in the power systems to maintain power quality. A contributing element to power quality is power factor. The power factor is typically a measure of how effectively input power is used in the power system. When the power factor is low (e.g., less than 0.9), it can contribute to equipment instability and failure and increases energy costs. As such, power factor correction equipment is often used in the power systems to maintain power quality. An example of such power factor correction equipment is a bank of capacitors to offset an inductive load in order to improve the power factor and hence the power quality. Another example of power factor correction equipment is a reactor bank when the load is capacitive.

Conventional power conversion systems can induce significant harmonics into the power system, which can cause heating, losses, and equipment failures. In order to filter out such harmonics, such power conversion systems typically include large harmonic filters which are very expensive and add to the cost of the already existing power conversion systems. Furthermore, the large harmonic filters may contribute to overall power losses in the electrical power systems, thus decreasing the overall efficiency of such power conversion systems.

In one aspect, the present invention is directed to a battery sourced power conversion system that addresses the above mentioned problems existing in the space of grid-scale energy storage systems by integrating energy storage equipment and power conversion equipment. In this regard, the integrated energy storage and power conversion system typically includes a plurality of battery units and a plurality of switches connected to the battery units. A controller is configured to control the operation of switches to charge or discharge the battery units for generating an output. The output of the system typically provides power conversion and/or compensation. Such power conversion and/or compensation may: provide power factor correction between a source and a load, change the form of power from the source (e.g., from AC to DC or DC to AC), change the voltage or frequency of power from the source, compensate for noise from the source, store excess power from the source, and/or provide previously stored energy when power demands of the load exceed the power being provided by the source. In an embodiment where the battery sourced power conversion system is connected to an AC source and an AC load, the battery sourced power conversion system may act as a compensation system connected in parallel to the source and the load to regulate the power delivered from the source to the load. In such an embodiment, the system may provide an output that provides power factor correction. In particular, the system output in combination with the source output form a load input having an improved power factor (e.g., a power factor close to unity), namely as compared to what the power factor of the load input would be without the corrective output of the system. In an embodiment where the battery sourced power conversion system is connected to a DC source and an AC load or to an AC source and a DC load, the battery sourced power conversion acts as a gateway in between the source and the load to deliver power which meets the requirements of the load. In such embodiment, the system may change the form of power from the source when delivering an output to the load (e.g., by converting AC power to DC power or converting DC power to AC power). Regardless of whether the battery sourced power conversion system is positioned as a gateway between the source and load or in parallel to the source/load, the battery sourced power conversion system may be configured to compensate for differences between power delivered by the source and power demanded by the load, such as by storing excess power from the source and/or provide previously stored energy when power demands of the load exceed the power being provided by the source. In some embodiments, the battery sourced power conversion system may compensate for noise in the output of the source. For example, the load may be a DC load and the source may be a noisy DC source. The system may generate an output that compensates (e.g., mirrors) the noise of the output of the DC source, thereby providing a less noisy input to the DC load.

The system is typically configured to generate a high-resolution output (e.g., an output having a resolution of 50 or more). In order to generate a high-resolution output, the system typically includes a plurality of individually controllable battery units. Typically, the number of battery units is at least as great as the resolution of the system output, although the number of battery units may exceed the resolution of the system output, such as to compensate for potentially faulty battery units and/or to allow the system to concurrently generate multiple outputs (e.g., a three-phase AC output). To achieve the system output, the controller is configured to control the operation of the switches so that each battery unit generates a square wave output. The square wave outputs of the battery units are combined to form the system output. The controller is further configured to control the timing of the switches so that the square wave outputs, when combined, form the desired system output. In an exemplary embodiment, where the output of the battery sourced power conversion system is connected to an AC load, the system output may be a substantially sinusoidal AC output. In order to generate such a substantially sinusoidal AC output, the controller is further configured to control the timing of the switches so that the square wave outputs, when combined, form a modified sinusoidal wave that substantially resembles a smooth sine wave, such as by forming a modified sinusoidal wave having a resolution of at least 50 (e.g., 200 or more).

By individually switching battery units in this manner to achieve a desired output (e.g., sinusoidal AC output, noise-correcting output, power factor correcting output, DC output, etc.), the harmonics introduced into the system are very small as compared to the harmonics induced by the conventional power conversion equipment. Accordingly, the power conversion system eliminates the need to use large, expensive harmonic filters. In addition, the battery sourced power conversion system as described herein is able to convert DC power to AC power, AC power to DC power, AC power to AC power, DC power to DC power (e.g., changing voltage levels) without the use of expensive power inverters and/or power converters and regulate the power factor without the use of additional power factor correction equipment. Accordingly, the battery sourced power conversion system described herein is able to provide less expensive energy storage and/or power conversion that can be integrated within power generation, transmission, and/or distribution systems than can be achieved through existing energy storage and power conversion systems.

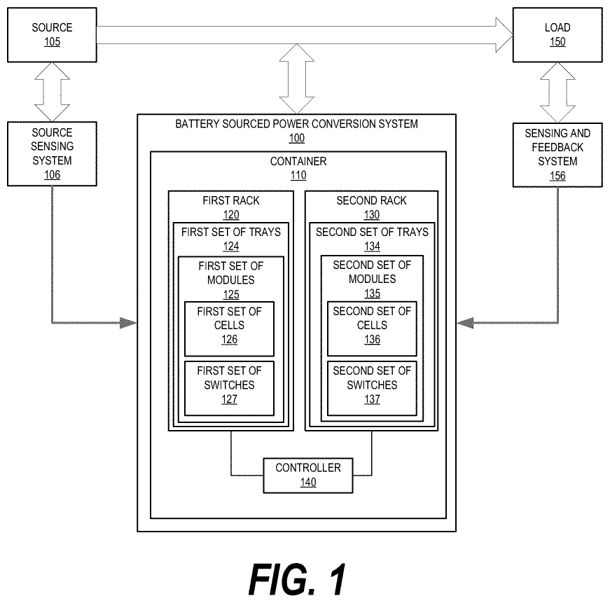

FIG. 1 illustrates a block diagram representing a battery sourced power conversion system 100 in accordance with an embodiment of the present invention. The battery sourced power conversion system 100 is typically connected to a source 105 and a load 150. In one embodiment, the source 105 is an AC source and the load 150 is an AC load. In another embodiment, the source 105 is a DC source and the load 150 is a DC load. In other embodiments, one of the source 105 or the load 150 is AC and one of the source 105 or the load 150 is DC. The source 105 may include one or more sources. The load 150 may include one or more loads. The system 100 may be directly connected to the source 105 and/or load 150. Alternatively, system 100 may be directly connected to the source 105 and load 150 by separate busses and/or transformers.

In some embodiments, the system 100 acts as a gateway between the source 105 and the load 150. When the system 100 acts as a gateway, power from the source 105 does not directly flow from the source 105 to the load 150, but instead power from the source 105 is delivered to the system 100 and the system 100 may then deliver an output to the load 150. In this regard, the system 100 may absorb power from the source 105 (e.g., by charging battery units of the system 100) and then generate an output (e.g., by discharging battery units) that meets the requirements of the load. In such embodiments, the battery sourced power conversion system 100 may perform power conversion, such as by converting a DC input to an AC output, or vice versa, or creating an output with a different voltage or frequency than the input. For example, DC power from the source 105 may be used to charge battery units of the system 100, and the system 100 may generate an AC output by controlling the discharge of the battery units to generate an AC waveform.

In other embodiments, the system 100 is connected in parallel to the source 105 and the load 150, such that the source 105 may directly delivery power to the load 150, but the system 100 may also deliver an output to the source/load. When the energy generation at the source 105 is greater than the requirements of the load 150, the excess energy from the source 105 may be used to charge battery units within the battery sourced power conversion system 100 and thereby store the excess energy. When the energy generation at the source 105 is less than the requirements of the load 150, the energy stored in the battery sourced power conversion system 100 may be discharged to the load 150 to meet the load requirements. In some embodiments, the battery sourced power conversion system 100 may (alternatively or additionally) deliver an output that provides power factor correction.

The battery sourced power conversion system 100 includes a plurality of battery units. In an exemplary embodiment, the battery sourced power conversion system 100 comprises at least one container 110, such container 110 comprising one or more racks. Each of the one or more racks may comprise one or more trays connected in series. In an embodiment, where the battery sourced power conversion system is connected to a three phase power system, one rack may be a single leg of a three phase battery sourced power conversion system. A first rack 120 comprising a first set of trays 124 and a second rack 130 comprising a second set of trays 134 are shown for illustrative purposes only.

The system 100 typically includes a plurality of switches to control the charging and discharging of individual battery units. By way of example, FIG. 1 illustrates each of the first set of trays 124 comprises a first set of modules 125 and each of the first set of modules 125 comprises a first set of cells 126 and a corresponding first set of switches 127 for the first set of cells 126. As shown, each of the second set of trays 134 comprises a second set of modules 135 and each of the second set of modules 135 comprises a second set of cells 136 and a corresponding second set of switches 137 for the second set of cells 136.

In one embodiment, a single switch may be connected to each cell (or other battery unit). In another embodiment, a plurality of switches may be connected to each cell in the battery sourced power conversion system to reduce the thermal effect on the switch corresponding to each cell. In another embodiment, a plurality of cells may be connected to a single switch. In yet another embodiment, a plurality of cells connected in series may be connected to a plurality of switches connected in parallel. In some embodiments, the switches used in the battery sourced power conversion system 100 may be solid state switches. In some other embodiments, the switches used in the battery sourced power conversion system 100 are mechanical switches. In some embodiments, the switches used in the battery sourced power conversion system may be a combination of both solid state switches and mechanical switches. In some embodiments, the battery sourced power conversion system 100 may include switches at the rack, module, and/or other battery unit level.

The cells may be any type of cell usable for high power applications. For example, the cells used in the battery sourced power conversion system 100 may be high-drain cells. In some embodiments, the cells used in the battery sourced power conversion system 100 have small voltage range (e.g., up to 5 volts). Typically, the voltage of a cell is determined based on cell chemistry. The number of racks, modules, and cells may vary based on the desired voltage output of the battery sourced power conversion system 100, as well as other considerations such as cost and availability. For example, if a cell with a voltage of 3 volts is the most economical, then ten cells may be stacked together to achieve 30 volts, whereas if a cell with a voltage range of 5 volts is alternatively the most economical, then six cells may be stacked together to achieve 30 volts.

The battery sourced power conversion system 100 also comprises a controller 140 to perform switching of the switches (e.g., the switches 127 and 137). The controller may be any controller such as a programmable logic controller, microcontroller, or the like. In some embodiments, the battery sourced power conversion system 100 may include a single controller for all containers. In some embodiments, the battery sourced power conversion system 100 may include one controller for each of the containers, wherein the controllers in each of the containers work cohesively to perform the switching operation. In some embodiments, the battery sourced power conversion system 100 may include controllers at the rack, tray, or module level and/or cell level. For example, the battery sourced power conversion system may include a controller for each cell. In another example, the battery sourced power conversion system may include one controller for each tray comprising a bundle of cells. In another example, the battery sourced power conversion system may include one controller for each rack comprising a bundle of trays. In some embodiments, the battery sourced power conversion system 100 may include a centralized controller at the system level and one or more controllers at battery unit level (e.g., cell level, module level, tray level, rack level, and/or container level) which work together to control the switching operation in order to achieve a desired output. With respect to FIG. 1, the controller 140 embedded within the container 110 controls the switches (e.g., the switches 127 and 137) connected to the cells in order to control the output supplied to the load 150.

The controller 140 may control the switching operation of battery units to provide power conversion and/or power matching which are explained in detail below. In one embodiment, the controller 140 may perform the switching operation based on the source output sensed by a source sensing system 106 and load requirements or load input provided by a sensing and feedback system 156 to provide a desired output from the system 100. The number of cells to be operated, the time interval of switching, and the number of steps in the output of the battery sourced power conversion system 100 is typically determined by the controller 140 based on the source output and load input. In some embodiments, the battery units may have the same number of sub-units. For example, all trays in the battery sourced power conversion system may have same number of modules and the modules may have same number of cells. In some embodiments, the battery units may have different number of subunits. For example, a first tray may have ten modules and a second tray may have 2 modules. In such an embodiment where the number of subunits in different battery units may vary, the battery units and subunits the controller may turn ON and OFF may depend upon at least the time interval and the desired output. For example, a tray having large number of cells may be used by the controller to generate a desired output at one time interval and a tray having small number of cells may be used by the controller to generate a desired output at a different time interval.

The controller 140 may control switching operation at a cell level (and/or at a module and/or rack level) to achieve a desired output by switching ON and OFF the switches corresponding to each of the cells and causing the cells to charge and discharge. When the controller switches ON a cell at a particular time, such cells produce a square wave output. These outputs of the plurality of cells when combined form the desired output with a resolution that is typically based on the number of cells employed. In order to achieve a desired output, various cells (or other battery units) may be charged and/or discharged for different lengths of time. In order to ensure that all cells have similar longevity and performance characteristics, the controller rotates the short-term duty cycle of the cells while charging and discharging so that the overall duty cycle of all the cells remains substantially the same. Maintaining the same overall duty cycle helps to prevent overcharging or undercharging of cells. By way of a simple example, if there are 3 cells (A, B, and C) in the battery sourced power conversion system and during time period t1, if cell A is turned ON for time T seconds, cell B is turned ON for time T/2 seconds, and cell C is turned ON for T/4 seconds, then during time period t2, cell A may be turned ON for T/4 seconds, cell B may be turned ON for T seconds, and cell C may be turned ON for T/2 seconds, and during time period t3, cell A may be turned ON for T/2 seconds, cell B may be turned ON for T/4 seconds, and cell C may be turned ON for T seconds. As such, the overall duty cycle of all cells within the battery sourced power conversion system remains substantially the same, even though the short term duty cycles of the cells may vary. In some embodiments, the concept of rotation may be implemented at module level, tray level, rack level, and/or container level. For example, if there are six trays in the battery sourced power conversion system, the controller may rotate the charging and/or discharging period of six trays, so that all six trays have the same overall duty cycle.

In one embodiment, the load connected to the battery sourced power conversion system may be a DC load and the source may be an AC source. In such an embodiment, the battery sourced power conversion system may act as a gateway and the controller 140 performs the switching operation to convert the input from the AC source to match the load requirements. In this regard, the controller 140 typically controls switching operation at a cell level (and/or at a module and/or rack level) so that the combined output of the cells is a substantially constant (e.g., constant other than low-level noise) DC waveform.

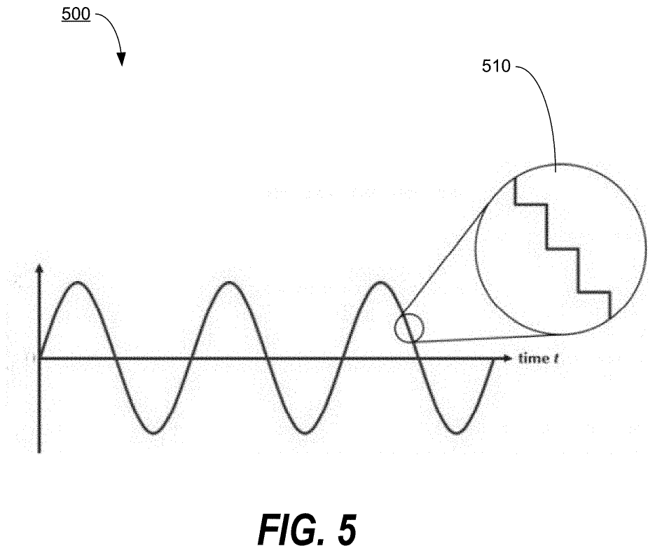

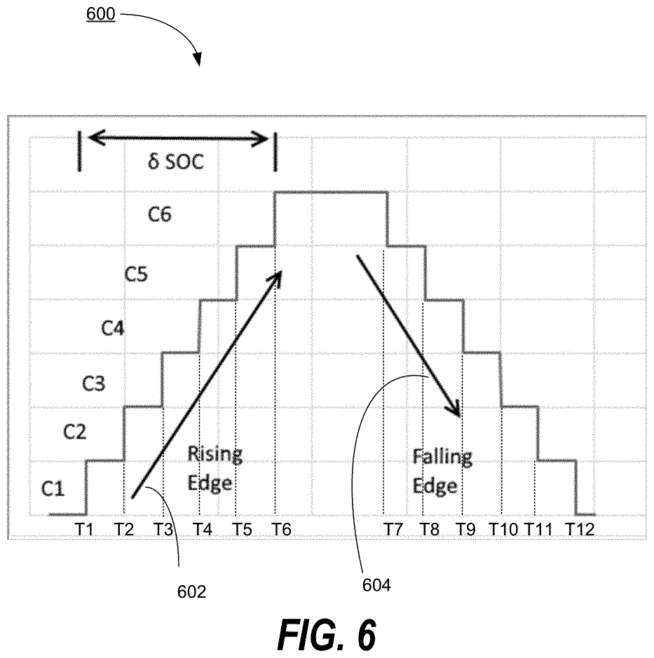

In another embodiment, the load connected to the battery sourced power conversion system may be an AC load and the source may be a DC source. Accordingly, the cells may be switched ON and OFF by the controller 140 so that the combined output of the cells is a sinusoidal output that substantially resembles a smooth sine wave. A simplified, exemplary output of such an embodiment is illustrated in FIG. 5. In this regard, the controller 140 typically controls switching operation at a cell level (and/or at a module and/or rack level) to achieve the modified sinusoidal waveform comprising a series of small steps 510 as shown in FIG. 5. When the controller switches ON a cell a particular time, such cells produce a square wave output. These outputs of the plurality of cells when combined forms the modified sinusoidal waveform 500. In particular, the modified sinusoidal waveform 500 is an n-level stair step sinusoidal wave comprising series of small n-level steps 510. FIG. 6 represents an expanded view 600 of a portion of the positive half cycle of the n-level modified sinusoidal waveform 500 comprising a plurality of steps. To achieve the step-shape of the waveform 500, the controller 140 varies the timing of the ON and OFF switching of different cells in order to achieve such discretized waveform. In particular, the controller 140 in the battery sourced power conversion system 100 controls the switching of the cells in order to achieve a gradual rise 602 and gradual fall 604. The rise and fall of the voltage is typically based on the number of cells which are turned ON and OFF. In one exemplary embodiment, where there are 6 cells (C1, C2, C3, C4, C5, and C6), the controller may turn ON C1 at time T1 or at 0 degrees and is kept ON for 180 degrees through time T12. In order to build the next steps of voltage, the controller may turn on cell C2 at time T2, C3 at time T3, C4 at time T4, C5 at time T5, and C6 at time T6 until the peak voltage is achieved. All the cells are in active mode between time T6 and time T7. At time T7, the cell C6 is turned OFF in order to step down the voltage and similarly other cells are turned OFF in a gradual manner until the voltage reaches zero. A separate set of cells configured at the opposite polarity may be switched ON and OFF to achieve the negative half of the AC waveform. These separate cells typically have a reverse polarity (as compared with the cells which are operating during the positive half of the waveform) to generate to generate square waves with negative voltages that in combination form the negative half of the AC waveform. For example, there may be six cells (C7, C8, C9, C10, C11, and C12) which may be used for switching to achieve the negative half cycle. The controller, to achieve the negative half cycle, may employ same kind of switching as explained above. For the next positive half of the cycle, the controller rotates the short-term duty cycle of the cells so that the overall duty cycle of the cells is substantially the same, which typically helps to prevent overcharging or undercharging of cells. For example, in the next positive half of the cycle, cell C2 may be turned ON for a large time period (T1 through T12) and cell C1 may be turned ON for a short time period (T6 through T7). In the next positive half of the cycle, cell 3 may be turned ON for a large time period (T1 through T12) and cell C2 may be turned ON for a short time period (T6 through T7). Although the short-term duty cycle may be rotated at the cell-level, alternatively the short-term duty cycle may be rotated at the level of different battery units (e.g., module level or tray level). By gradually switching the cells (or other battery units) of the power conversion system in the above manner and by gradually controlling the voltage, the power conversion system 100 can achieve a sinusoidal (or other varying) output without the use of expensive power inverters. Such gradual switching (as opposed to abrupt voltage changes) also helps to eliminate large harmonics and the need to use large, expensive filters to filter out those harmonics. In other words, the controller 140 harmoniously controls the switching of cells in order to achieve a stair step sinusoidal output comprising n-levels of series of steps, as achieving peak amplitude abruptly typically introduces harmonics into the system.

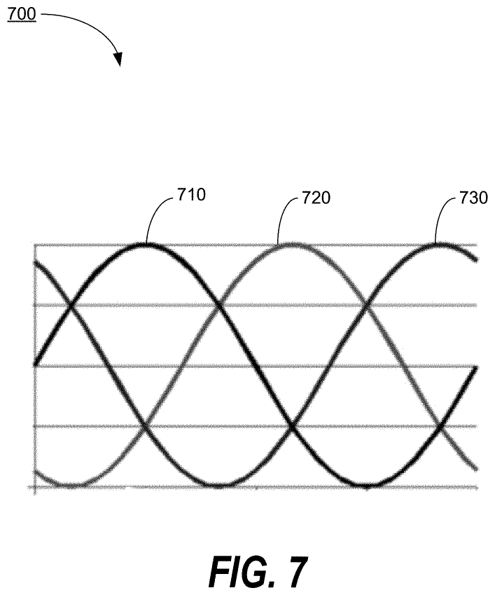

The battery sourced power conversion system is typically able to achieve an output with a resolution of greater than 50, such as resolution of at least 100 (e.g., 500 or more). As used herein, “resolution” refers to the number of possible voltage levels that can be achieved by the system. Where the output of the system is a modified sinusoidal output, the resolution is equal to the number of steps in the modified sinusoidal output within one period. By way of illustration, if FIG. 7 were to represent the positive portion of one period of a modified sinusoidal output, such modified sinusoidal output would have a resolution of 12 (i.e., the 6 steps shown in FIG. 7, plus 6 mirrored steps in the negative half of the waveform).

In an exemplary embodiment, wherein the battery sourced power conversion system is connected to a 3 kV AC load operating at 60 Hz, and the battery sourced power conversion system comprises cells with a voltage of 3 volts, the number of steps in the sinusoidal output would be 1414. Continuing with the previous example, if the number of steps is 1414, the time between each switch is 0.005 ms. The cells in the battery sourced power conversion system 100 are switched ON and OFF at a different time during a cycle to obtain the desired output. Where the desired output is an AC sinusoidal waveform, the controller typically uses a set of cells configured in the opposite polarity in the battery sourced power conversion system 100 to handle the negative output of the sinusoidal output waveform. The controller may employ similar kind of switching method which is gradual in order to achieve a DC or other (e.g., noise correcting) output wave.

Similarly, the controller 140 operates switches to perform power conversion and/or compensation when both the source and the load connected to the battery sourced power conversion system 100 are AC systems. Typically, the load 150 may include resistive, inductive, and/or capacitive loads. Capacitive and inductive loads store energy which can cause the current to move out of phase with the voltage in an AC system and in turn result in a poor power factor. When a load is inductive (e.g., an electric motor), current typically lags voltage, thereby increasing the reactive power in the power system. The increase in the reactive power causes the total apparent power in the power system to increase, thereby resulting in a low power factor which can have detrimental effects on the power system. The battery sourced power conversion system compensates for the lag induced by inductive loads by causing the cells or battery units to absorb or discharge current in order to produce a resulting current waveform which is in-phase with the voltage, thereby improving or correcting the power factor of the power system without using any additional equipment.

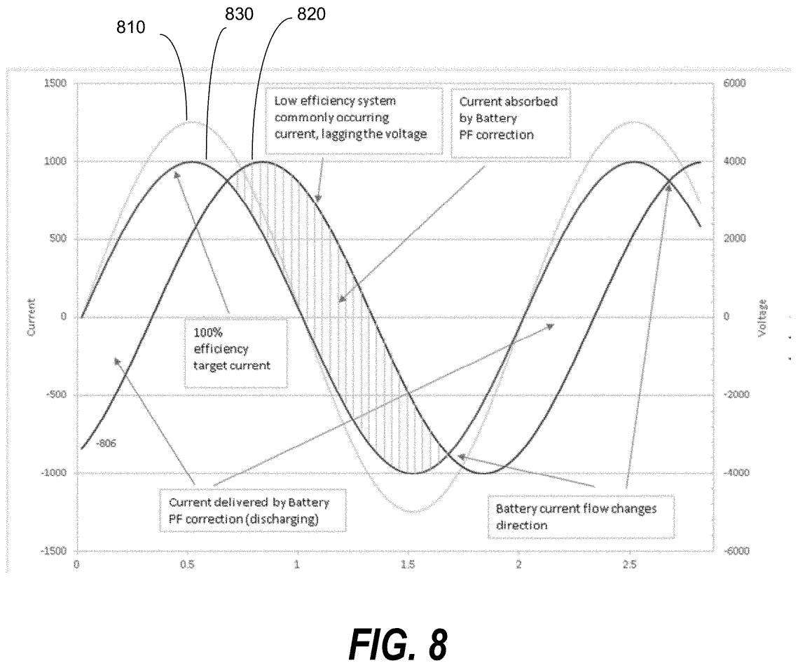

An illustration of power factor correction performed by the battery sourced power conversion is shown in FIG. 8. As shown, waveform 810 represents source voltage and waveform 820 represents the source current which is out of phase with the source voltage. In this embodiment, the source current lags the source voltage. In another embodiment, the source current may lead the source voltage when the load is capacitive in nature. The controller in the battery sourced power conversion system 100 compensates for the lag by turning the switches ON and OFF in order to cause the cells or battery units in the battery sourced power conversion system 100 to absorb and discharge current. For example, as shown in the FIG. 8, at time 0, the source voltage is 0V and the source current is −806 A. The controller operates the switches in order to cause the battery sourced power conversion unit to provide+806 A in order to provide matching current. In other example, as shown in FIG. 8, at time 1, the source voltage is 0V and the source current is approximately 900 A. The controller operates the switches in order to cause the battery sourced power conversion unit to absorb 900 A to provide matching current. As a result, the battery sourced power conversion system 100, by absorbing or discharging current, compensates for the lag by generating an output that when combined with the source output produces a resulting current waveform 830 which is in-phase with the source voltage waveform 810. As such, the battery sourced power conversion system 100 improves the power factor of the load input without needing additional power factor correction equipment.

The battery sourced power conversion system 100 may also compensate for low or high power generation at the source and/or high or low power consumption at the load irrespective of whether the source and the load are AC or DC. In one example, when the power generation at the source is low and the power consumption is high at the load, the controller 140 may control the switching at cell level (and/or module level, tray level, and/or rack level) to discharge previously charged cells in order to compensate for the low supply of power.

In order to achieve a desired output waveform, a transfer function may be used by the controller 140 to control the switching operation of the cells (and/or other battery units). In other words, software of the controller 140 employs the transfer function to control the switches in order turn battery units ON and OFF to thereby obtain a desired output. Such transfer function may be determined based on multiple variables and the coefficients of the developed transfer function are fed into the controller 140 to achieve the desired switching operation for a resulting waveform. Such variables may include power throughput, cell configuration (cell chemistry, number of cells, architecture of cells, or the like), selection of components, allowed system voltage and current limits, and the like. In some embodiments, the process of determining the transfer function may be performed by a processor and the coefficients of the developed transfer function may be fed to the controller 140. The processor may automatically calculate the transfer function based on the inputs received from the source sensing system 106 and the sensing and feedback system 156. The transfer function may vary for different type of sources and loads. For example, when the source is an AC source and the load is an AC load, the transfer function associated with such a power system may be different when compared with the transfer function of a power system comprising a DC source and a DC load. In other words, transfer functions may vary based on the different types of conversion that is being performed by the battery sourced power conversion system.

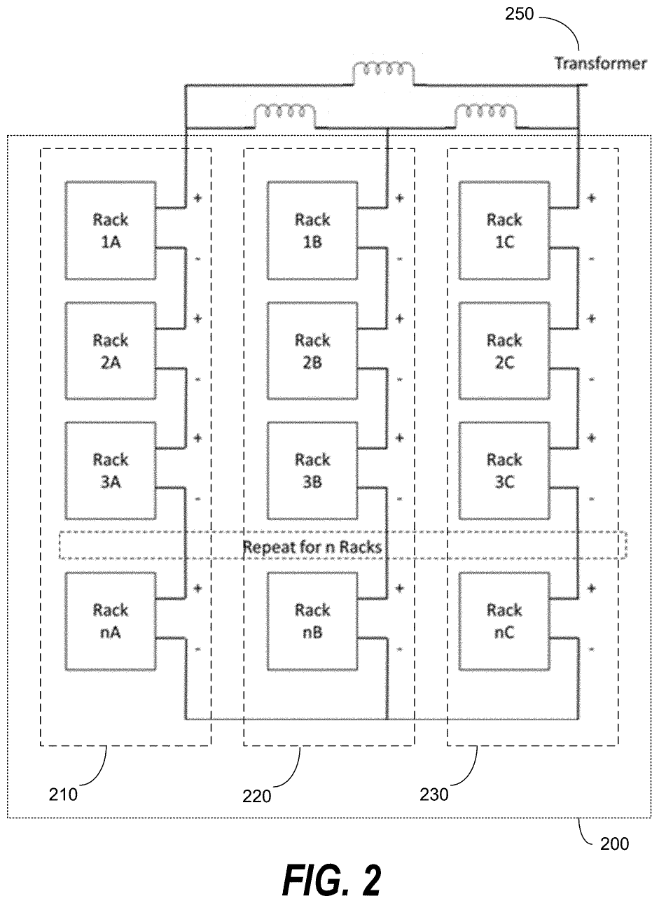

FIG. 2 illustrates a battery sourced power conversion system 200 in accordance with an embodiment of the present invention that is configured to deliver three-phase power. As shown, the system 200 may include three sets of racks 210, 220, and 230 (or other battery units). Each set of racks includes a plurality of racks, namely Rack 1A through Rack nA, Rack 1B through Rack nB, and Rack 1C through Rack nC, connected in series. The sets of racks are connected to an internal side of a three-phase transformer 250. The internal side of the three-phase transformer 250 shown in FIG. 2, which is in the form of “delta,” is for illustrative purposes only. The three-phase battery sourced power conversion system may be connected to an internal side of the transformer, which may be in “wye” form. The battery sourced power conversion system 200, in one embodiment, may produce a three-phase sinusoidal output 800 as illustrated in FIG. 8. In this regard, each set of racks produces a sinusoidal output 810, 820, and 830, where each sinusoidal output 810, 820, and 830 is 120 degrees apart. The one or more controllers in the battery sourced power conversion system 200 may control the output of individual cells (and/or other battery units) within each set of racks in order to obtain the sinusoidal outputs 810, 820, and 830 in one embodiment.

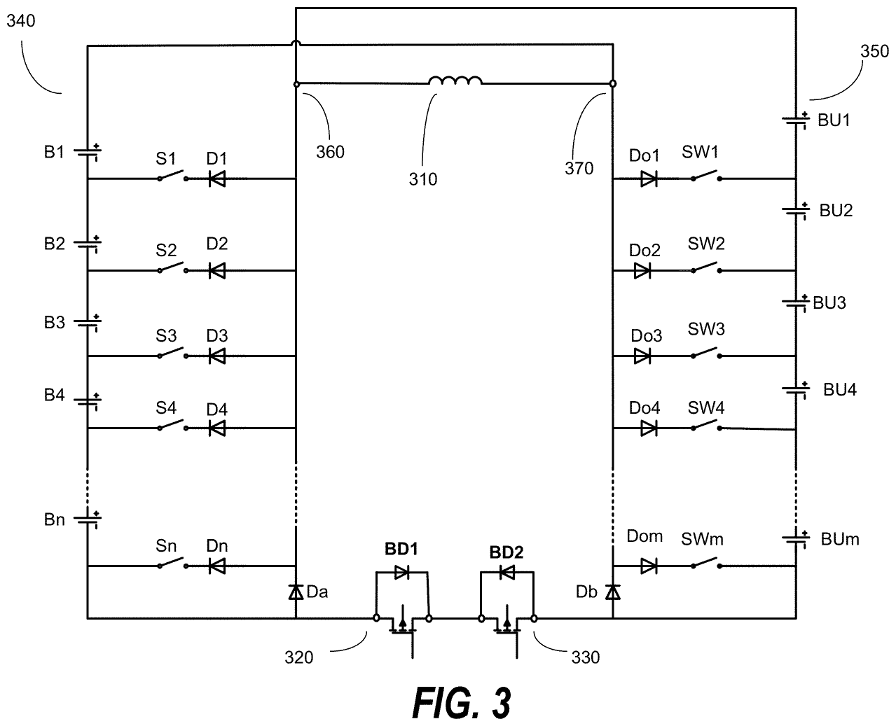

FIG. 3 illustrates a different embodiment of a balanced architecture utilized in the battery sourced power conversion system. As shown, two sets of stringed battery units (B1, B2, through Bn and BU1, BU2, through BUm) connected in series to a transformer 310. The battery units B1, B2, through Bn are employed by the system to supply a positive voltage (e.g., to form the positive portion of an AC output). The battery units BU1, BU2, through Bum have a reverse polarity when compared with the battery units B1, B2, through Bn and are employed to supply a negative voltage (e.g., to form the negative portion of an AC output). The battery units may be cells, modules, trays, racks, and/or containers and the balanced architecture illustrated in FIG. 3 may be applied to cell level, module level, tray level, rack level, and/or container level. For example, the battery units may be cells contained within a module or tray. Each of the battery units may include a corresponding switch (S1, S2 through Sn and SW1, SW2, through SWm) and a diode (D1, D2, through Dn and Do1, Do2, through Dom). The controller may close or open the switches corresponding to each cell to activate or deactivate each of the battery units. Switch Sn and SWm are main current switches and other switches shown in FIG. 3 are transitional switches which are switched ON and OFF to achieve a desired output. In some embodiments, the switches Sn and SWm may not be connected to corresponding diodes (e.g., Dn and Dom). As shown there are equal number of stringed battery units connected in series to two legs (340 and 350) of the transformer 310, which results in a balance structure. In other words, for every cell in leg 340 there is a mirror cell in leg 350 of the transformer 310 and is similar to a single battery where the positive terminal and a negative terminal of the battery are connected to a single leg of a transformer. The terminals 360 and 370 of the transformer 310 may be tapped for supplying output of the balanced architecture to the load. As shown, the battery units connected in series are connected to two MOSFET's 320 and 330 which act as a bypass mechanism to all the battery units shown in FIG. 3. In one exemplary embodiment, the battery units shown in the FIG. 3 may be cells in a tray and the MOSFET's 320 and 330 may act as a bypass to that tray. The tray may be connected to ‘n’ number of trays with MOSFET's acting as a bypass for each tray. The bypass mechanism shown in FIG. 3 may also be used for switching of trays when the multiple such balanced architectures are stringed together, when the switching is performed at tray level. As alternative to the MOSFET's 320 and 330, other bypass mechanisms may be employed. The balanced architecture described herein provides a net zero voltage potential when the system is at rest. In other words, the individual voltages of the stack of battery units (B1, B2, through Bn and BU1, BU2, through BUm) collectively yield a combined voltage of approximately zero when they are all in OFF state, as a result of half the battery units having reversed polarity. Accordingly, even though the system may be designed to operate at high voltages (e.g., thousands of volts), the overall voltage of the system at rest is approximately zero, thereby improving the overall safety of the system.

Additional components (such as sensors at the battery unit level, mechanical bypass switches at the individual, filters) may be present in the battery sourced power conversion system along with the elements shown in FIG. 3. In some embodiments, the filter used in the battery sourced power conversion system 100 may be a low pass filter. In some embodiments, the filter used in the battery sourced power conversion system 100 may be a choke filter. In order to filter out the small amount of harmonics that may be caused by opening or closing of switches in battery sourced power conversion system a filter may be placed in parallel to the stringed battery units connected in series.

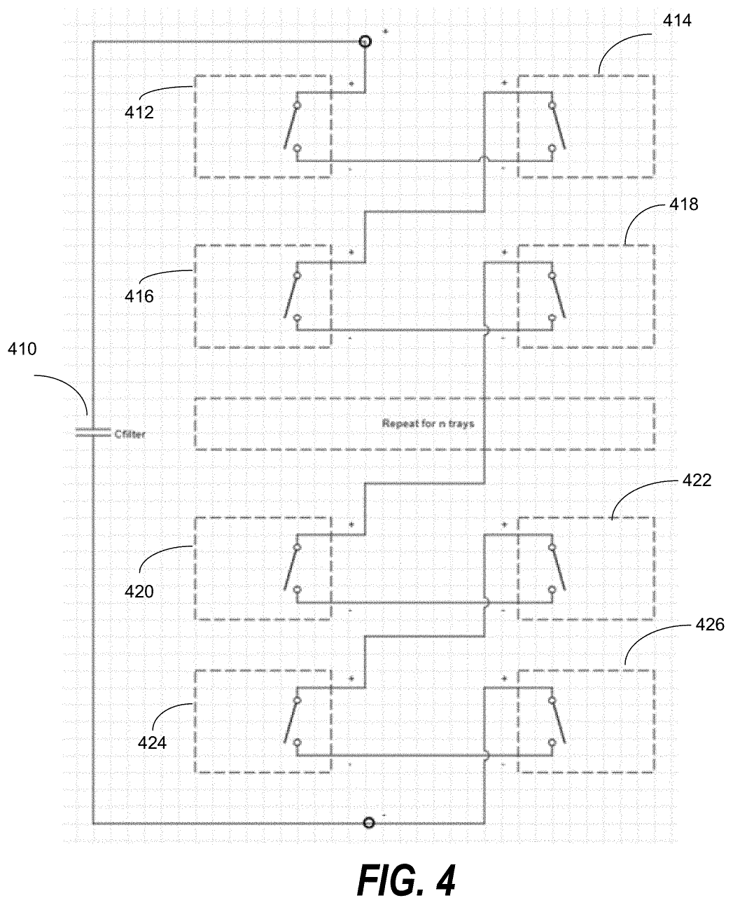

FIG. 4 illustrates an embodiment of a balanced architecture that may be utilized in the battery sourced power conversion system described herein. In contrast with the embodiment illustrated in FIG. 3 in which balancing occurs at the cell-level, balancing is achieved using higher level battery units in the embodiment illustrated in FIG. 4. In particular, FIG. 4 depicts four trays, each of which includes two modules, although it will be appreciated that the trays and modules depicted in FIG. 4 may be replaced with different types and/or quantities of battery units. In this regard, FIG. 4 depicts module 412 and module 414 in tray ‘1,’, module 416 and module 418 in tray ‘2,’ module 420 and module 422 in tray ‘n+1’, and module 424 and module 426 in tray ‘n+2.’ As further illustrated in FIG. 4, the modules in each tray are connected in series; however, one of the two modules in each tray is connected so that the polarity of its terminals is reversed. Because the polarities of half the modules depicted in FIG. 4 are reversed, these reverse polarity modules may be employed to supply a negative voltage (e.g., to form the negative portion of an AC output), whereas the other modules may be employed to supply a positive voltage. As depicted in FIG. 4, each tray and/or module may include a switch/bypass mechanism, which may be used to activate and deactivate such tray and/or module and/or isolate such tray and/or module if the tray/module becomes defective or has reached its charging or discharging potential. Although not depicted in FIG. 4, each modules typically includes multiple individually controllable cells (or other battery units) that be selectively and individually charged and/or discharged in order to form a high-resolution output. A rack level filter 410 may be connected in parallel to such racks to filter out harmonics that may be generated.

Although the battery sourced power conversion system described herein is typically for delivering power exceeding 10 kilowatts (kW), the battery sourced power conversion system may be used to deliver power below 10 kilowatts (kW).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation. In addition, where possible, any terms expressed in the singular form herein are meant to also include the plural form and/or vice versa. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein.

What is claimed:

1. A battery sourced power conversion system comprising:
a first plurality of battery units connected in series;
a first plurality of switches, wherein each of the first plurality of switches is connected to one of the first plurality of battery units; and
at least one controller connected to the first plurality of battery units, wherein the at least one controller is configured to control the first plurality of switches to generate a square wave output from one or more of battery units of the first plurality of battery units, wherein the square wave output of the one or more battery units of the first plurality of battery units in combination form a modified sinusoidal wave having a plurality of steps.

2. The battery sourced power conversion system of claim 1, comprising:
a second plurality of battery units connected in series;
a second plurality of switches, wherein each of the second plurality of switches is connected to one of the second plurality of battery units;
a third plurality of battery units connected in series; and
a third plurality of switches, wherein each of the third plurality of switches is connected to one of the third plurality of battery units;
wherein the at least one controller is connected to the second plurality of battery units and the third plurality of battery units.

3. The battery sourced power conversion system of claim 2, wherein;
the at least one controller is configured to control the second plurality of switches to generate a square wave output from one or more battery units of the second plurality of battery units, wherein the square wave output of the one or more battery units of the second plurality of battery units in combination form a second modified sinusoidal wave having a plurality of steps; and
the at least one controller is configured to control the third plurality of switches to generate a square wave output from one or more battery units of the third plurality of battery units, wherein the square wave output of the one or more battery units of the third plurality of battery units in combination form a third modified sinusoidal wave having a plurality of steps.

4. The battery sourced power conversion system of claim 3, wherein the modified sinusoidal wave, second modified sinusoidal wave, and third modified sinusoidal wave in combination form a three-phase modified sinusoidal output.

5. A battery sourced power conversion system comprising:
a plurality of battery units;
a plurality of switches, wherein each of the plurality of switches is connected to one of the plurality of battery units; and
at least one controller connected to the plurality of battery units, wherein the at least one controller is configured to control the plurality of switches to generate a square wave output from one or more battery units of the plurality of battery units, wherein the square wave output of the one or more battery units of the plurality of battery units in combination form an output having a resolution of at least 50.

6. A battery sourced power conversion system connected to a load and a source, the system comprising:
a plurality of battery units connected in series;
a plurality of switches, wherein each of the plurality of switches is connected to one of the plurality of battery units; and
at least one controller connected to the plurality of battery units, wherein the at least one controller is configured to:
generate, using the plurality of battery units, a system output, the system output being substantially equal to a difference between an output of the source and a desired input of the load, wherein the system output is generated by controlling the plurality of switches to generate a square wave output from one or more battery units of the plurality of battery units, wherein the square wave output of the one or more battery units of the plurality of battery units in combination form the system output.

7. The battery sourced power conversion system of claim 6, wherein the system output has a resolution of greater than 50.

8. The battery sourced power conversion system of claim 6, wherein the system output has a resolution of greater than 100.

9. The battery sourced power conversion system of claim 6, wherein the system output has a resolution of greater than 500.

10. The battery sourced power conversion system of claim 6, wherein the output of the source comprises a source voltage and a source current, wherein the source voltage is out-of-phase with source current, wherein the desired input comprises a desired input voltage and a desired input current, wherein the desired input voltage is in-phase with the desired input current.

11. The battery sourced power conversion system of claim 10, wherein the system output when combined with the source current forms the desired input current.

12. The battery sourced power conversion system of claim 10, wherein providing the desired input current is based on absorbing current.

13. The battery sourced power conversion system of claim 10, wherein providing the desired input current is based on discharging current.

14. The battery sourced power conversion system of claim 6, wherein the at least one controller is configured to control the plurality of switches to maintain substantially the same overall duty cycle for each of the plurality of battery units.

15. The battery sourced power conversion system of claim 6, wherein the at least one controller is configured to control the plurality of switches to compensate for lower generation of the output of the source by discharging charged battery units of the plurality of battery units.

16. The battery sourced power conversion system of claim 6, wherein the at least one controller is configured to control the plurality of switches to compensate for higher generation of the output of the source by charging discharged battery units of the plurality of battery units.

17. The battery sourced power conversion system of claim 6, wherein the system further comprises a bypass mechanism for the plurality of battery units.

18. The battery sourced power conversion system of claim 6, wherein a first set of battery units of the plurality of battery units are configured to supply positive voltage and a second set of battery units of the plurality of battery units are configured to supply negative voltage, the second set of battery units having reverse polarity compared to the first set of battery units.

19. The battery sourced power conversion system of claim 6, wherein the at least one controller is configured to control the plurality of switches to achieve a gradual rise and gradual fall of voltage.

20. The battery sourced power conversion system of claim 6, wherein the at least one controller is configured to control the plurality of battery units based on a transfer function.
